(19) United States
(12) Patent Application Publication
(10) Pub. No.: US 2025/0177858 A1
(43) Pub. Date: Jun. 5, 2025

(54) APPARATUS, SYSTEMS AND METHODS FOR VISUAL DESCRIPTION

(71) Applicant: Sony Interactive Entertainment Inc., Tokyo (JP)

(72) Inventors: Ryan John Spick, London (GB); Timothy Edward Bradley, Didcot (GB); Guy David Moss, Tunbridge Wells (GB); Pierluigi Vito Amadori, London (GB); Ayush Raina, San Francisco, CA (US)

(21) Appl. No.: 18/962,239

(22) Filed: Nov. 27, 2024

(30) Foreign Application Priority Data
Dec. 5, 2023 (GB) 2318557.2

(51) Int. Cl. A63F 13/52

(52) U.S. Cl. CPC A63F 13/52

(57) ABSTRACT

A data processing apparatus comprises a captioning model to receive gameplay telemetry data indicative of one or more in-game properties for a session of a video game, the captioning model comprising an artificial neural network (ANN) trained to output caption data comprising one or more captions in dependence upon a learned mapping between gameplay telemetry data and caption data, one or more of the captions comprising one or more words for providing a visual description for the session of the video game, and output circuitry to output one or more of the captions.

### CROSS REFERENCE TO RELATED APPLICATIONS

The present application claims priority to United Kingdom (GB) Application No. 2318557.2, filed Dec. 5, 2023, the contents of which is incorporated by reference herein in its entirety for all purposes.

### BACKGROUND

### Field of the Disclosure

The present disclosure relates to the field of processing data. In particular, the present disclosure relates to apparatus, systems and methods for providing caption data for describing video games.

### Description of the Prior Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior against the present disclosure.

Visual description techniques exist for providing a description of visual information within a displayed content. For users with visual impairment, such descriptions can be crucial for their understanding of the content. Visual description techniques can generally be used to describe events, actions and other visual properties in a pre-recorded content, such as a movie or a television show for example, so as to improve usability of pre-recorded content for users with visual impairment and/or cognitive impairment.

Conventional visual description techniques rely on manual creation of descriptive transcripts for content and potentially the use of human voice actors to obtain a corresponding audio recording. Such techniques can be labour intensive, time consuming and costly. In addition, such techniques have meant that visual description has typically been limited to use with pre-recorded content.

There is therefore a need to improve visual description.

It is in this context that the present disclosure arises.

Various aspects and features of the present disclosure are defined in the appended claims and within the text of the accompanying description. Example embodiments include at least a data processing apparatus, a method, a computer program and a machine-readable, non-transitory storage medium which stores such a computer program.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating an example of an entertainment device;

FIG. 2 is a schematic diagram illustrating a data processing apparatus for providing one or more captions;

FIG. 3 is a schematic diagram illustrating a system;

FIG. 4 is a schematic diagram illustrating another data processing apparatus;

FIG. 5 is a schematic flowchart illustrating an example method for generating training data;

FIG. 6 is a schematic diagram illustrating a data processing apparatus for generating training data;

FIG. 7 is a schematic diagram illustrating respective sets of labelled training data;

FIGS. 8 and 9 are schematic diagrams illustrating data processing apparatuses; and

FIG. 10 is a schematic flowchart illustrating a method.

### DETAILED DESCRIPTION

In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

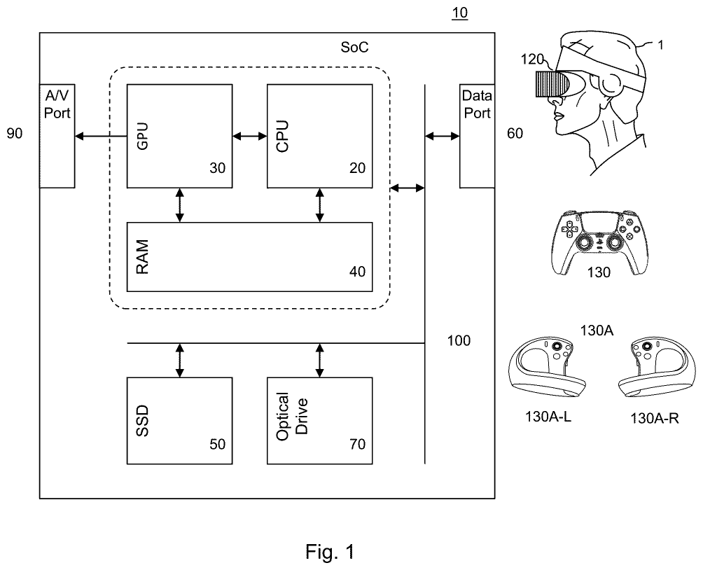

Referring now to the drawings, wherein like reference numerals designate identical or corresponding parts, FIG. 1 shows an example of an entertainment device 10 which may be a computer or video game console, for example.

The entertainment device 10 comprises a central processing unit (CPU) 20. This may be a single or multi core processor. The entertainment device also comprises a graphical processing unit or GPU 30. The GPU can be physically separate to the CPU, or integrated with the CPU as a system on a chip (SoC).

The GPU, optionally in conjunction with the CPU, may process data and generate video images (image data) and optionally audio for output via an AV output. Optionally, the audio may be generated in conjunction with or instead by an audio processor (not shown).

The video and optionally the audio may be presented to a television or other similar device. Where supported by the television, the video may be stereoscopic. The audio may be presented to a home cinema system in one of a number of formats such as stereo, 5.1 surround sound or 7.1 surround sound. Video and audio may likewise be presented to a head mounted display unit worn by a user.

The entertainment device also comprises RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive, or an internal solid state drive.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90, or through one or more of the wired or wireless data ports 60.

An example of a device for displaying images output by the entertainment device is a head mounted display ‘HMD’ 120, worn by a user 1. The images output by the entertainment device may be displayed using various other devices—e.g. using a conventional television display connected to A/V ports 90.

Where components are not integrated, they may be connected as appropriate either by a dedicated data link or via a bus 100.

Interaction with the device is typically provided using one or more handheld controllers, such as the handheld controller 130, and/or one or more VR controllers 130A-L,R in the case of the HMD. The user typically interacts with the system, and any content displayed by, or virtual environment rendered by the system, by providing inputs via the handheld controllers 130, 130A. For example, when playing a game, the user may navigate around the game virtual environment by providing inputs using the handheld controllers 130, 130A.

FIG. 1 therefore provides an example of a data processing apparatus suitable for executing an application such as a video game.

Traditional content captioning techniques typically rely on analysis of video images to perform video image captioning. Content captioning techniques may rely on analysis of video image sequences to detect and caption various image features by analysis of individual image frames and/or temporal analysis of multiple image frames. Storage, transmission and/or analysis of video images can be computationally expensive. In addition, associated latencies arising from storage, transmission and/or analysis of video image sequences can be potentially restrictive.

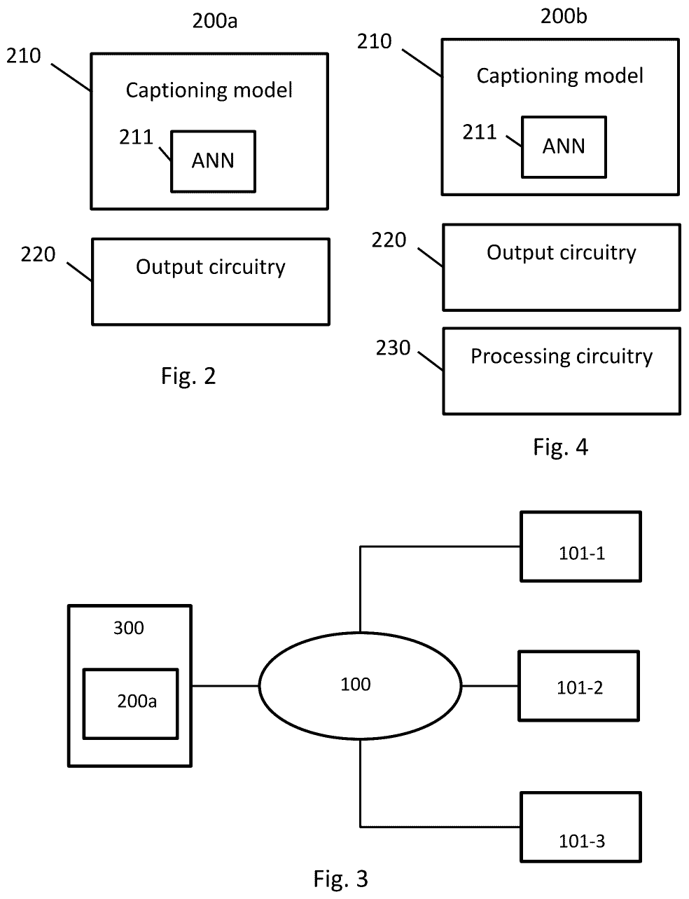

FIG. 2 schematically illustrates a data processing apparatus 200a in accordance with embodiments of the disclosure. The data processing apparatus 200a is suitable for providing caption data for visually describing one or more sessions of one or more video games. The data processing apparatus 200a comprises a captioning model 210 and output circuitry 220. The data processing apparatus 200a may be provided as part of a server and/or as part of a user device (e.g. an entertainment device such as that in FIG. 1).

The captioning model 210 is configured to receive gameplay telemetry data indicative of one or more in-game properties for a session of a video game. The received gameplay telemetry data may be pre-recorded gameplay telemetry data and/or live gameplay telemetry data. Hence, the techniques of the present disclosure may be suitable for providing visual description for one or more recorded sessions and/or one or more live sessions of one or more video games. During execution of a session of a video game, in addition to generating video and audio for output to a user, gameplay telemetry data can also be generated. Gameplay telemetry data may be generated for video games for various purposes such as game analytics, debugging and/or business intelligence among others. More generally, gameplay telemetry data can be generated during execution of a video game for indicating one or more in-game properties.

In some cases, developers may specify one or more conditions associated with a video game for which gameplay telemetry data is to be generated. In response to an occurrence of the condition, gameplay telemetry data may be generated which indicates one or more in-game properties. For example, in response to a user selecting a given weapon or other similar object (e.g. a vehicle) during a game, gameplay telemetry data may be generated to indicate properties such as a type and/or name of the given weapon (or given vehicle), a type and/or name of an associated game character as well as other potential properties such as a position and/or velocity and/or damage status (e.g. health status) associated therewith. For example, in the case of a racing game, gameplay telemetry data may be generated to indicate properties such as a velocity and/or ranking, and one or more conditions may be specified such as reaching certain points on a racing circuit and/or passing another car for generating such gameplay telemetry data. The gameplay telemetry data may take any suitable form. Gameplay telemetry data generated during a session of a video game may have a format that is dependent on the program code associated with the video game. Gameplay telemetry data may comprise text data (e.g. one or more strings), numerical values (e.g. counters, timers), and/or event identifiers for indicating one or more in-game properties for a session of a video game.

More generally, the received gameplay telemetry data is indicative of one or more in-game properties for the session of the video game. The gameplay telemetry data may be received from another device, such as a server or a user device (e.g. an entertainment device such as that in FIG. 1), via one or more of a wired and/or wireless communication. For example, the gameplay telemetry may be generated by a server associated with a cloud gaming platform. In some examples, the gameplay telemetry may be generated by a game console device associated with a user. In some examples, first gameplay telemetry data may be received from a first device (e.g. a sever) and second gameplay telemetry data may be received from a second device (e.g. a user device). The first gameplay telemetry data and the second gameplay telemetry data may relate to single player sessions of a same or different video game or may, in some cases, relate to a multiplayer video game.

FIG. 3 schematically illustrates an example of a system in which the data processing apparatus 200a is provided as part of a server apparatus 300. The system comprises the server apparatus 300 which communicates with the client devices 101-1, 101-2 and 101-3 via the network 100 (which may be any suitable communications network). In the example of FIG. 3, the client devices may each be associated with a different user. The data processing apparatus 200a may receive gameplay telemetry data generated by each of the client devices. Hence, in the case in which video games are at least partially executed locally by user devices, gameplay telemetry can be communicated to and received by the data processing apparatus 200a for use according to the techniques to be discussed below for proving captions. Alternatively, in the example of FIG. 3, the server 300 may be a game server (or other similar server) that at least partially executes one or more video games and streams video images for reception by the client devices. Hence, the data processing apparatus 200a may receive gameplay telemetry data generated by the server 300 for use according to the techniques to be discussed below for proving captions.

Whilst FIG. 3 shows an example of a system comprising three client devices, the number of client devices is not particularly limited and there may be any suitable number of client devices. The number of client devices is not particularly limited and other similar examples are considered. For example, the system could potentially comprise a single client device. Alternatively, the system could potentially comprise a large number of respective client devices of the order of tens, hundreds or even thousands.

Still referring to FIG. 3, the data processing apparatus 200a may be configured to receive gameplay telemetry data associated with an executed instance of a video game. The server 300 may execute a number of instances of a video game which may be a single player video game or a multiplayer video game. Similarly, the client devices 101-1, 101-2 and 101-3 may each execute a respective instance of a video game. More generally, the data processing apparatus 200a may be configured to receive first gameplay telemetry data associated with a first instance of a video game, receive second gameplay telemetry data associated with a second instance of a video game, and receive third gameplay telemetry data associated with a third instance of a video game.

Hence, the data processing apparatus 200a may be configured to receive respective gameplay telemetry data for each of a plurality of respective instances of one or more video games. The data processing apparatus 200a may be configured to output respective caption data for each of the plurality of respective instances of the one or more video games according to the techniques to be discussed below.

Whilst FIG. 3 shows an example in which the data processing apparatus 200a is provided as part of a server, in other examples the data processing apparatus 200a may be provided as part of a client device (user device) such as any of the client devices 101-1, 101-2 and 101-3.

In some embodiments of the disclosure, the gameplay telemetry may be recorded and may relate to a previous session for a video game. In such cases the gameplay telemetry may be downloaded to the data processing apparatus 200a and stored. In some embodiments of the disclosure, the gameplay telemetry may be streamed to the data processing apparatus 200a and may relate to a current (i.e. live) game session or a recorded game session. For example, the data processing apparatus 200a may be provided as part of a server device which is operable to receive gameplay telemetry data for one or more video game sessions and provide captions for the video game sessions.

Referring again to FIG. 2, the captioning model 210 comprises an artificial neural network (ANN) 211 trained to output caption data comprising one or more captions in dependence upon a learned mapping between gameplay telemetry data and caption data. The captioning model 210 thus inputs at least some of the received gameplay telemetry data to the trained ANN 211 which outputs caption data comprising one or more captions in dependence upon the input gameplay telemetry data. One or more of the captions comprise one or more words for providing a visual description for the session of the video game. Generally, one or more of the captions comprise one or more words for providing a visual description for what can be expected to be observed in a video image and/or video image sequence associated with the session of the video game. However, the trained ANN 211 outputs the caption data in dependence on the gameplay telemetry data images for the session of the video game without requiring video images associated with the session of the video game.

The artificial neural network (ANN) 211 generally comprises an input layer, one or more hidden layers and an output layer. At least some of the received gameplay telemetry data can be input to the input layer and the layers provide the functionality of mapping the input to one or more captions for providing a visual description. The ANN 211 can be trained using supervised learning techniques to be discussed below. The ANN 211 is a processor-implemented artificial neural network which may be implemented using one or more of: one or more CPUs, one or more GPUs, one or more FPGAs, and one or more deep learning processors (DLP).

The output circuitry 220 circuitry is configured to output one or more of the captions. In some embodiments of the disclosure, the output circuity 220 may output the caption data without any modification. In some embodiments of the disclosure, the caption data may be processed by apparatus 200a prior to being output by the output circuity 220. For example, the caption data may be processed to select a subset of the captions for output. Alternatively, or in addition, caption data comprising a plurality of captions may be processed to combine some or all of the captions into a single combined description. Such techniques are discussed in more detail later.

More generally, the data processing apparatus 200a is operable to receive gameplay telemetry data for a session of a video game and output one or more captions for providing a visual description for the session of the video game. Captioning of telemetry data can be used to obtain one or more captions for the session of the video game. In this way, the techniques of the present disclosure can provide captions for a video game potentially without requiring storage, transmission and/or analysis of video images thus providing a number of technical advantages.

Gameplay telemetry data indicative of one or more in-game properties for a session of a video game can have a significantly smaller data size comparative to that of an associated sequence of video images for visually depicting the session. The techniques of the present disclosure provide the captioning model 210 (also referred to as a gameplay telemetry data captioning model) that can provide caption data for describing a session of a video game using the gameplay telemetry data. In this way, caption data for describing a session of a video game can be provided without the need for processing of video images. Hence, caption data can potentially be obtained more quickly than conventional video captioning techniques and with a reduced computational load.

Captions output by the output circuitry 220 may be used for a range of different purposes. For example, the captions may be output to a client device so as to provide a description (e.g. one or more of a text-based and/or audio-based description) to accompany the video images for the video game. For example, this may be useful for a player user and/or a spectator user (i.e. a user observing a game played by one or more player users) with one or more accessibility issues (e.g. vision loss). The captions may for example provide a summary of one or more events in the video game and may include a description of a game trajectory, temporal activity, intent, and goals. Alternatively, or in addition, the captions may be useful for game analytics and/or game debugging purposes. The captions can provide a visual description for the session of the video game using the gameplay telemetry data and can potentially be used for testing occurrence of errors and/or anomalies within a game. Alternatively, or in addition, in some cases the captions may be useful as an input to a policy model for training a gaming AI (such as a non-player character) to play a video game. For example, the captions may be useful as an auxiliary input to train policy models for a gaming AI which may assist in faster and more efficient training of gaming AIs. In particular, the caption data may be used as a low-dimensional input for policy models. This can potentially enhance the scene understanding of policy models and improve the learning process. The caption data may potentially be used with, or as a substitute for, image input for policy models.

Execution of video games may generate gameplay telemetry data for various purposes such as debugging and/or game analytics and/or business intelligence among others. For example, gameplay telemetry data may be used for identifying behaviours and interactions by users, such as whether users are making use or not making use of certain aspects (e.g. using a given object such as a weapon or vehicle) of a video game. More generally, as part of the execution of the video game, gameplay telemetry data can be generated for indicating one or more in-game properties for the session of the video game. The gameplay telemetry can be generated by a game engine and may have been, at least initially, intended by a game developer to be used for collecting information about a user's session of a video game. In the techniques of the present disclosure, the ANN 211 has been trained to map gameplay telemetry data indicative of one or more in-game properties to caption data.

Hence, in some embodiments of the disclosure, execution of a video game may generate video game data comprising video images for the video game and also gameplay telemetry data indicative of one or more in-game properties for the session of the video game.

The gameplay telemetry data may be indicative of in-game properties such as a number and/or type of objects located in a video game environment and/or an action or actions of characters (players and/or non-player characters) in the video game environment or the like. In some embodiments of the disclosure, the gameplay telemetry data may be indicative of one or more in-game properties comprising one or more from the list consisting of: at least one of a type and a name for one or more in-game objects; a position of one or more in-game objects; a velocity for one or more in-game objects; a health status for one or more in-game characters; and a score associated with at least one of a character and a team.

Further examples of in-game properties for a session of a video game which may be indicated by the gameplay telemetry data may include one or more collidable objects, within sight of a player, weapon use, vehicle use, trajectory, item/asset use, character/kit choice, level/map selection, loss/win status, team scores, character jumps/crouches/special moves, damage inflicted, damage sustained and so on.

In some video games, gameplay telemetry data may be generated and provide an indication of one more in-game events occurring within the video game. For example, in-game events that may be indicated by the gameplay telemetry data may comprise one or more of a player dying, a goal being scored, a car crashing, etc. Other in-game events such as obtaining a trophy, killing an opponent, making a headshot, drifting around a corner, etc. may be used. This data may be input to the ANN 211 for providing one or more captions.

FIG. 4 schematically illustrates a data processing apparatus 200b in accordance with embodiments of the disclosure. The data processing apparatus 200b comprises the captioning model 210 and the output circuitry 220 as discussed previously. In addition, the data processing apparatus 200b comprises processing circuitry 230. The processing circuitry 230 is configured to execute the video game and generate video images and the gameplay telemetry data. Hence, some embodiments of the disclosure provide the data processing apparatus 200b which is operable to execute a session of a video game and generate video images (and optionally associated audio) for output to a user and also generate the gameplay telemetry data. The processing circuitry 230 can be configured to execute the video game in accordance with inputs from a user. User inputs may be provided via any suitable input device such as a handheld controller device and/or an HMD or other similar device. User inputs may be received via one or more of a wired and/or wireless communication.

Hence, the data processing apparatus 200b can generate video images for the session of the video game and, using the captioning model 210, one or more captions can be provided in dependence on the gameplay telemetry data. One or more of the captions may potentially be used to generate one or more of a text-based and/or an audio-based (e.g. using text-to-speech processing for at least some of the captions) visual description to accompany the video images. Of course, in other cases, execution of the video game can be performed by another apparatus. For example, the data processing apparatus 200a may be a server apparatus that is a dedicated caption providing apparatus.

Referring again to FIG. 2, the ANN 211 is trained to learn a mapping between gameplay telemetry data and caption data. In response to an input comprising gameplay telemetry data associated with a session of a video game and indicative of one or more in-game properties for the session, the ANN 211 outputs caption data comprising one or more captions for providing a visual description for the session. The one or more captions provide a visual description of what can be expected to be visually observed when viewing video images for the video game, however, rather than using video images the ANN 211 uses the gameplay telemetry data.

In some embodiments of the disclosure, supervised learning techniques using labelled training data may be used to train the ANN 211. Generally, the ANN 211 can be trained using supervised learning to learn a function for mapping an input comprising gameplay telemetry data to an output indicative of one or more captions.

In some embodiments of the disclosure, the ANN 211 may be trained using training data comprising gameplay telemetry data and corresponding labels associated with captions comprising words providing a visual description of video images associated with the gameplay telemetry data. Hence, using such labelled training data, the ANN 211 can be trained to learn a function for mapping an input (gameplay telemetry data) to an output (one or more captions) based on example input and output pairs. Put differently, using such labelled training data, the ANN 211 can be trained to learn to caption input gameplay telemetry data by predicting one or more labels for the input gameplay telemetry data. The training data may be obtained by manual labelling or automated labelling techniques, or a combination thereof. Multi-label classification techniques may be used. For example, the training data may comprise first respective gameplay telemetry data indicative of a first set of one or more in-game properties and one or a plurality of respective labels associated with one or more captions. Similarly, the training data may comprise second respective gameplay telemetry data indicative of a second set of one or more in-game properties and one or a plurality of respective labels associated with one or more captions.

In some embodiments of the disclosure, the ANN 211 may be trained using training data in which at least some of the training data comprises manually labelled gameplay telemetry data. Manual labelling of gameplay telemetry data may be achieved using data recorded from one or more previous gameplay sessions for one or more video games. Recorded video (and optionally audio) for a previous gameplay session may be played back to a user. The user can manually create captions for the recorded video, potentially with two or more captions being provided for a same or at least partially overlapping segment of the recorded video. Captions may potentially comprise anywhere between a single word and a number of words suitable for constructing a sentence. Captions can thus be manually created for segments of the video. The captions for the recorded video can be associated with the recorded gameplay telemetry data. For example, timestamps associated with the recorded gameplay telemetry data and the corresponding recorded video may be used ensure that the captions are correctly associated with the portion of the recorded gameplay telemetry data corresponding to the portion of the recorded video for which the captions have been created. In this way, training data comprising gameplay telemetry data and corresponding captions can be obtained. For example, for a video image (or sequence of video images) showing a car driving down a street busy with pedestrians, one or more suitable captions can be provided and the corresponding (temporally corresponding) gameplay telemetry data can be associated with one or more of the captions.

The above techniques represent one possibility for obtaining suitable training data for training the ANN 211. In some embodiments of the disclosure, the ANN 211 may be trained using training data in which at least some of the training data comprises automatically labelled gameplay telemetry data comprising labels associated with captions obtained, by a video captioning model, for the video images associated with the gameplay telemetry data. Video captioning techniques are generally known. Such techniques typically input video images to a video captioning model (which may in some cases be trained using deep learning techniques) to obtain captions for describing events, actions and or other aspects represented in the video images. In some embodiments of the disclosure, a video captioning model (optionally using a trained processor-implemented ANN for mapping features in video images to captions) may be used to provide captions for recorded video images for a session of a video game. The captions for the recorded video images can then be associated with the corresponding recorded gameplay telemetry data for the session of a video game. In this way, training data can be obtained which comprises gameplay telemetry data automatically labelled with associated captions.

The ANN 211 may be trained using training data which may comprise one or both of manually labelled gameplay telemetry data and automatically labelled gameplay telemetry data.

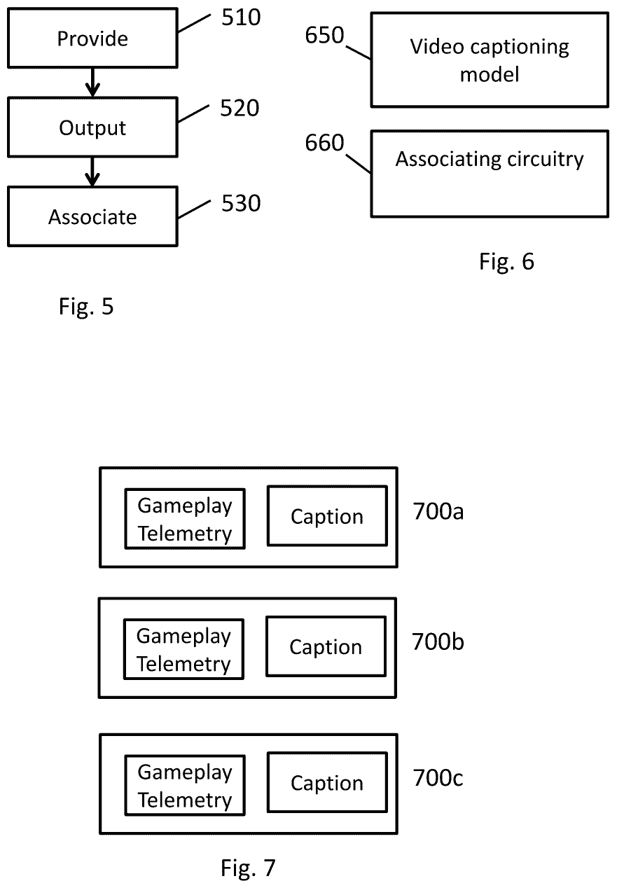

FIG. 5 is a schematic flowchart illustrating a method of generating training data comprising gameplay telemetry data and labels associated with captions for providing a visual description for video images associated with the gameplay telemetry data. The method comprises:
providing (at a step 510), to a video captioning model, an input comprising at least recorded video images associated with one or more video games, the video captioning model being trained for outputting caption data comprising one or more captions in dependence on one or more video images, each caption comprising one or more words for visually describing one or more properties of the content represented in the video images,
outputting (at a step 520), by the video captioning model, caption data comprising one or more captions in dependence on one or more of the recorded video images; and
associating (at a step 530) one or more of the captions with recorded gameplay telemetry data.

The step 530 of associating one or more of the captions with recorded gameplay telemetry data may be performed by matching portions (time segments) of the recorded video with corresponding portions (time segments) of the recorded gameplay telemetry. As mentioned previously timestamp matching techniques may be used for this. The recorded video images may potentially relate to a number of different video games of varying genres. In some cases, the recorded video images may relate to a plurality of respective video games of a same video game series or a same video game genre. Example techniques in this respect are discussed in more detail later.

Referring now to FIG. 6, in some embodiments of the disclosure, a data processing apparatus 600 for generating training data comprises: a video captioning model 650 and associating circuitry 660. The video captioning model 650 may comprise a trained ANN (not shown in FIG. 6) to receive a video image sequence comprising a plurality of video images and output caption data comprising one or more captions in dependence upon a learned mapping between video images and caption data. The associating circuitry 660 is operable to receive gameplay telemetry data associated with the video image sequence and associate at least some of the captions with the gameplay telemetry data by associating a caption output for a segment of the video images with a corresponding segment of the gameplay telemetry data. The data processing apparatus 600 can thus be used for generating training data which can be used for training the ANN 211.

In some embodiments of the disclosure, the captioning model 210 comprises one or more from the list consisting of: a first ANN trained using training data associated with a first video game; a second ANN trained using training data associated with a second video game different from the first video game; a third ANN trained using training data associated with a plurality of related video games of a same video game series; and a fourth ANN trained using training data associated with a plurality of video games of a same video game genre. In the above discussion, the terms first, second, third and fourth are used to distinguish between the respective ANNs and may be used interchangeably. Any of the first, second, third or fourth ANN may be used as the ANN 211 discussed previously with respect to FIGS. 2 and 4.

The first ANN is trained using training data associated with a first video game. The first ANN can be trained specifically for a given video game. The given video game may be any suitable video game and may be any of a racing video game, first person shooter video game, role playing video game and so on. In this case, the training data may be obtained by performing one or both of the manual and automated techniques discussed above using recorded data from one or more previous game sessions by one or more users for the given video game. More specifically, for previous game sessions, recordings of video images and the corresponding gameplay telemetry data can be used to obtain captions and the captions associated with the gameplay telemetry data.

The second ANN is trained using training data associated with a second video game. The second ANN can be trained using the same technique as that discussed above with respect to the first ANN, but with the difference being that the training data is obtained using recordings from a different video game. For example, whereas the first ANN may be trained for a video game such as a soccer (football) related video game, the second ANN may be trained for another video game such as a racing game. Hence, when the received gameplay telemetry data relates to a soccer related video game, for example, input of the received gameplay telemetry data to the first ANN may be more appropriate, whereas when the received gameplay telemetry data relates to a driving game, input of the received gameplay telemetry data to the second ANN may be more appropriate.

It can be desirable to train an ANN using training data associated with a specific video game. For example, using an ANN trained for a specific video game may improve an accuracy of the captions. However, training an ANN using training data associated with a specific video game can potentially be problematic due to, for example, limited availability of suitable training data and/or reduced performance when using the ANN for providing captions for one or more other video games.

The third ANN is trained using training data associated with a plurality of related video games of a same video game series. Recorded data for a plurality of respective video games each belonging to a same video game series may be used for the training data for training a respective ANN. This can be particularly useful in that the third ANN can be trained for a video game series (potentially with no or little training data for a given video game of the video game series) and used to output caption data for any video game of the video game series. In particular, for a newly or more recently released video game of the video game series (for which there may be little or no available training data), the third ANN may be used to allow accurate and reliable provision of captions.

In a similar manner, the fourth ANN is trained using training data associated with a plurality of video games of a same video game genre. Recorded data for a plurality of respective video games each belonging to a same video game genre may be used for the training data for training a respective ANN. Hence, the fourth ANN may be specifically trained for a given video game genre. Any suitable video game genre may be used. In some examples, the captioning model 210 may comprise a plurality of respective ANNs each trained using training data associated with a set of video games of a same video game genre.

In some examples, a set of training data may comprise any of the above-mentioned labelled gameplay telemetry data and may also comprise one or more of the corresponding video images. Whilst supervised learning techniques are possible using the labelled gameplay telemetry data, in some cases video images may also be used for performing a joint training technique using a joint loss to potentially case training. Even in such cases, video images would potentially be used in training (perhaps only for initial stages of training) and inference by the ANN 211 would be carried out as discussed previously (i.e. without video images).

FIG. 7 is a schematic illustration of three respective sets of training data. The sets of training data may each be generated according to the techniques discussed above. In some examples, the data processing apparatus 600 may be operable to generate the sets of training data. The set of training data 700a comprises gameplay telemetry data and associated captions for a first video game. The set of training data 700a may thus be used for training the above mentioned first ANN. The set of training data 700b comprises gameplay telemetry data and associated captions for a plurality of related video games of a same video game series. The set of training data 700b may thus be used for training the above mentioned third ANN. The set of training data 700c comprises gameplay telemetry data and associated captions for a plurality of video games of a same video game genre. The set of training data 700b may thus be used for training the above mentioned fourth ANN.

In some embodiments of the disclosure, the captioning model 210 is configured to receive the gameplay telemetry data indicative of one or more in-game properties for a session of a video game and associated metadata indicative of at least one of a video game title, video game series and video game genre for the video game, and the captioning model 210 is configured to input the received gameplay telemetry data to a respective ANN selected from a plurality of ANNs in dependence on the associated metadata. The captioning model 210 can be operable to use the associated metadata to select a preferred ANN from a plurality of ANNs. Using the metadata, the captioning model 210 may firstly detect whether there is an ANN trained for a same video game title. In response to detecting that there is an ANN trained for a same video game title, then the captioning model 210 is operable to select the ANN trained for the same video game title. If the captioning model 210 does not comprise an ANN trained for a same video game title, the captioning model 210 may detect whether there is an ANN trained for a same video game series. In response to detecting that there is an ANN trained for a same video game series, then the captioning model 210 is operable to select the ANN trained for the same video game series. If the captioning model 210 does not comprise an ANN trained for a same video game series, the captioning model 210 may detect whether there is an ANN trained for a same video game genre. In response to detecting that there is an ANN trained for a same video game genre, then the captioning model 210 is operable to select the ANN trained for the same video game genre.

The above discussion provides a possible technique for using metadata to select and use a respective ANN from among a plurality of available ANNs for providing caption data. Of course, in some embodiments of the disclosure, the captioning model 210 may comprise a respective ANN trained using training data associated with a range of different video games of different video game genres and the above mentioned first to fourth ANNs represent optional examples.

In some embodiments of the disclosure, the captioning model 210 is configured to receive recorded gameplay telemetry data for a recorded session of the video game and input at least some of the recorded gameplay telemetry data to the ANN. In some embodiments of the disclosure, the captioning 210 model is configured to receive streamed gameplay telemetry data for a live session of the video game and input at least some of the streamed gameplay telemetry data to the ANN.

In some embodiments of the disclosure, the captioning model 210 is configured to receive respective streamed gameplay telemetry data for each of a plurality of respective instances of one or more video games and to output respective caption data for each of the plurality of respective instances of the one or more video games. The captioning model 210 may receive respective streamed gameplay telemetry data for a potentially large number of respective instances of one or more video games. The captioning model 210 can be operable to process each of the respective streamed gameplay telemetry data and output respective caption data. In the case of running multiple instances of high-resolution video games, the processing overhead associated with the transmission, storage and/or analysis of video images can potentially introduce delays and processing bottle necks when attempting to provide captions. In contrast to such techniques, in the present disclosure the gameplay telemetry data (having a smaller processing overhead comparative to a video image feed) can be input to the ANN 211 for providing captions thus potentially allowing fast and efficient captioning for a potentially large number of parallel video game instances.

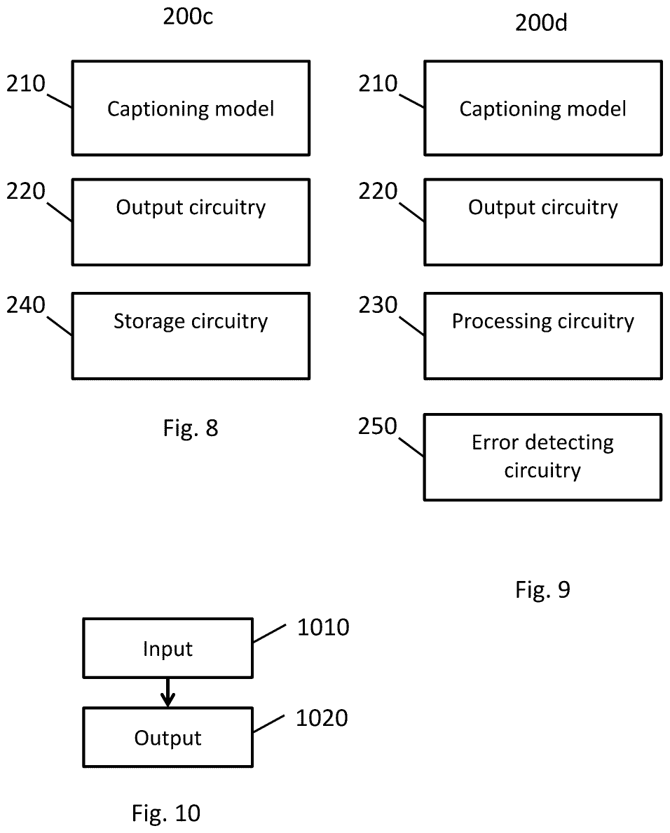

FIG. 8 schematically illustrates a data processing apparatus 200c in accordance with embodiments of the disclosure. The data processing apparatus 200b comprises the captioning model 210 and the output circuitry 220 as discussed previously. In addition, the data processing apparatus 200b comprises storage circuitry 240. The data processing apparatus 200c comprises the storage circuitry 240 for storing caption data output by the ANN 211. Hence, in some cases caption data output by the ANN 211 may be stored by the storage circuitry 240. For example, gameplay telemetry data for a session of a video game may be input to the ANN 211 and caption data for the session of the video game may be stored by the storage circuitry 240. In some examples, caption data for a live session of a video game may be written to the storage and upon the session ending, the output circuitry 220 may output the stored caption data. Alternatively, or in addition, caption data for a pre-recorded session of a video game may be written to the storage and upon completing processing of the gameplay telemetry data for the session and providing caption data for the session, the output circuitry 220 may output the stored caption data. Hence, caption data comprising one or more captions can be output by the ANN 211 and stored.

In some examples, the data processing apparatus may comprise natural language processing circuitry (not shown in FIG. 8) to process the caption data and generate modified caption data. The data processing apparatus 200 may perform one or more natural language processing techniques for one or more of the captions. For example, for a plurality of captions corresponding to a same time-based segment of the gameplay telemetry data, natural language processing may be used to generate a combined caption based on the plurality of captions, in which the combined caption comprises a one or more descriptive sentences based on the content of the plurality of captions. Hence, the storage circuitry 240 can be operable to store caption data output by the ANN 211 for a session of a video game, the natural language processing circuitry can be operable to generate modified caption data in dependence on the caption data (e.g. by generating one or more combined captions), and the output circuitry 220 can be operable to output the modified caption data.

FIG. 9 schematically illustrates a data processing apparatus 200d in accordance with embodiments of the disclosure. The data processing apparatus 200d comprises the captioning model 210, the output circuitry 220 and the processing circuitry 230 as discussed previously. In addition, the data processing apparatus 200d comprises error detecting circuitry 250.

The processing circuitry 230 is the same as has been discussed previously with respect to FIG. 4. However, whereas the previous discussion referred to execution in accordance with user inputs, the discussion with respect to FIG. 9 refers to execution in accordance with inputs from a virtual agent. The processing circuitry 230 can be configured to execute a video game in accordance with inputs from a virtual agent (e.g. a so-called game AI, or non-player character, that can play a video game). The processing circuitry 230 can be configured to execute the video game in accordance with inputs from the virtual agent and generate gameplay telemetry data. The error detecting circuitry 250 can be configured to detect one or more errors associated with the session of the video game in dependence on one or more of the captions outputted by the ANN 211. Hence, rather than using video images analysis techniques for error detection (e.g. bug detection) for the video game, in the present disclosure the apparatus 200d can use the gameplay telemetry data to obtain or more captions (via the ANN 211) and analyse one or more of the captions using the error detecting circuitry 250. For example, in response to a caption indicative of a description such as “avatar A repeatedly walks into the door”, the error detecting circuitry 250 can be operable to generate error data indicative of an occurrence of an error for the session of the video game.

Hence, in some embodiments of the disclosure, the processing circuitry 230 can be configured to execute the video game in accordance with inputs from a virtual agent and generate the gameplay telemetry data with or without generating video images. Since the virtual agent plays the game and error detection can be provided via the gameplay telemetry data, the video game can potentially be tested for errors without having to generate video images. Of course, in some examples, video images may also be generated and may also be provided for error detection (by detecting anomalies in images). However, the techniques of the present disclosure can potentially allow for fast and computationally efficient error testing of video games. Progression rate for execution of a video game is typically restricted by the need to generate video images with a suitable frame rate. The techniques of the present disclosure can permit error testing of video games based on gameplay by a game AI and using gameplay telemetry data for error detection which can potentially allow for faster and more efficient error testing for video games.

Whilst FIGS. 2, 4, 8 and 9 schematically illustrate possible forms of data processing apparatuses 200a-d, it will be appreciated that a respective data processing apparatus (or data processing system) may comprise any suitable combination of the elements 210, 220, 230, 240, 250. In some examples, a system may be provided comprising any suitable number of devices and any suitable combination of the elements 210, 220, 230, 240, 250. For example, a system may comprise a first processing device comprising the processing circuitry 230 and a second processing device comprising the captioning model 210 and the output circuitry 220 (and optionally the storage circuitry 240 and/or the error detecting circuitry 250). Alternatively, or in addition, the system may comprise a third processing device comprising the error detecting circuitry 250. Hence, in some embodiments of the disclosure, a system may comprise a device for executing a video game and generating gameplay telemetry data, a second device for providing caption data in dependence on the gameplay telemetry data, and a third device for performing error detection (e.g. bug testing) for the video game in dependence on the caption data.

FIG. 10 is a schematic flowchart illustrating a method in accordance with embodiments of the disclosure. The method comprises:
inputting (at a step 1010) gameplay telemetry data indicative of one or more in-game properties for a session of a video game to a captioning model, the captioning model comprising an artificial neural network (ANN) trained to output caption data comprising one or more captions in dependence upon a learned mapping between gameplay telemetry data and caption data; and
outputting (at a step 1020), by the ANN, caption data comprising one or more captions, one or more of the captions comprising one or more words for providing a visual description for the session of the video game.

It will be appreciated that example embodiments can be implemented by computer software operating on a general purpose computing system such as a games machine. In these examples, computer software, which when executed by a computer, causes the computer to carry out any of the methods discussed above is considered as an embodiment of the present disclosure. Similarly, embodiments of the disclosure are provided by a non-transitory, machine-readable storage medium which stores such computer software.

It will also be apparent that numerous modifications and variations of the present disclosure are possible in light of the above teachings. It is therefore to be understood that within the scope of the appended claims. the disclosure may be practised otherwise than as specifically described herein.

What is claimed is:

1. A data processing apparatus comprising:
one or more processors; and
one or more memories storing instructions that, upon execution by the one or more processors, configure the data processing apparatus to:
provide a captioning model that is configured to receive gameplay telemetry data indicative of one or more in-game properties for a session of a video game, wherein the captioning model comprises an artificial neural network (ANN) trained to output caption data comprising one or more captions in dependence upon a learned mapping between gameplay telemetry data and caption data, wherein one or more of the captions comprise one or more words for providing a visual description for the session of the video game; and
present one or more of the captions.

2. The data processing apparatus according to claim 1, wherein the ANN is trained using training data comprising gameplay telemetry data and corresponding labels associated with captions comprising words providing a visual description of video images associated with the gameplay telemetry data.

3. The data processing apparatus according to claim 2, wherein at least some of the training data comprises manually labelled gameplay telemetry data.

4. The data processing apparatus according to claim 2, wherein at least some of the training data comprises automatically labelled gameplay telemetry data comprising labels associated with captions obtained, by a video captioning model, for the video images associated with the gameplay telemetry data.

5. The data processing apparatus according to claim 4, wherein the video captioning model comprises an artificial neural network (ANN) trained to output caption data comprising one or more captions in dependence upon a learned mapping between video images and caption data.

6. The data processing apparatus according to claim 1, wherein the captioning model is configured to receive recorded gameplay telemetry data for a recorded session of the video game and input at least some of the recorded gameplay telemetry data to the ANN.

7. The data processing apparatus according to claim 1, wherein the captioning model is configured to receive streamed gameplay telemetry data for a live session of the video game and input at least some of the streamed gameplay telemetry data to the ANN.

8. The data processing apparatus according to claim 1, wherein the captioning model is configured to receive respective streamed gameplay telemetry data for each of a plurality of respective instances of one or more video games and to output respective caption data for each of the plurality of respective instances of the one or more video games.

9. The data processing apparatus according to claim 1, wherein the captioning model comprises one or more from the list consisting of:
a first ANN trained using training data associated with a first video game;
a second ANN trained using training data associated with a second video game different from the first video game;
a third ANN trained using training data associated with a plurality of related video games of a same video game series; and
a fourth ANN trained using training data associated with a plurality of video games of a same video game genre.

10. The data processing apparatus according to claim 1, wherein:
the captioning model is configured to receive the gameplay telemetry data and associated metadata indicative of at least one of a video game title, video game series and video game genre for the video game; and
the captioning model is configured to input the received gameplay telemetry data to a respective ANN selected from a plurality of ANNs in dependence on the associated metadata.

11. The data processing apparatus according to claim 1, wherein the gameplay telemetry data is indicative of one or more in-game properties comprising one or more from the list consisting of:
at least one of a type and a name for one or more in-game objects;
a position of one or more in-game objects;
a velocity for one or more in-game objects;
a health status for one or more in-game characters; and
a score associated with at least one of a character and a team.

12. The data processing apparatus according to claim 1, wherein the execution of instructions further configures the data processing apparatus to execute the video game and generate video images and the gameplay telemetry data.

13. The data processing apparatus according to claim 1, wherein the execution of instructions further configures the data processing apparatus to:
execute the video game in accordance with inputs from a virtual agent and generate the gameplay telemetry data; and
detect one or more errors associated with the session of the video game in dependence on one or more of the captions.

14. A computer implemented method comprising:
inputting gameplay telemetry data indicative of one or more in-game properties for a session of a video game to a captioning model, wherein the captioning model comprises an artificial neural network (ANN) trained to output caption data comprising one or more captions in dependence upon a learned mapping between gameplay telemetry data and caption data; and
outputting, by the ANN, caption data comprising one or more captions, wherein one or more of the captions comprise one or more words for providing a visual description for the session of the video game.

15. The computer implemented method of claim 14, wherein the ANN is trained using training data comprising gameplay telemetry data and corresponding labels associated with captions comprising words providing a visual description of video images associated with the gameplay telemetry data.

16. The computer implemented method of claim 15, wherein at least some of the training data comprises manually labelled gameplay telemetry data.

17. The computer implemented method of claim 15, wherein at least some of the training data comprises automatically labelled gameplay telemetry data comprising labels associated with captions obtained, by a video captioning model, for the video images associated with the gameplay telemetry data.

18. The computer implemented method of claim 17, wherein the video captioning model comprises an artificial neural network (ANN) trained to output caption data comprising one or more captions in dependence upon a learned mapping between video images and caption data.

19. The computer implemented method of claim 14, wherein the captioning model is configured to receive recorded gameplay telemetry data for a recorded session of the video game and input at least some of the recorded gameplay telemetry data to the ANN. 20 A non-transitory computer-readable medium storing computer executable instructions, which when executed by a processor, causes a computer system to perform operations comprising:
inputting gameplay telemetry data indicative of one or more in-game properties for a session of a video game to a captioning model, wherein the captioning model comprises an artificial neural network (ANN) trained to output caption data comprising one or more captions in dependence upon a learned mapping between gameplay telemetry data and caption data; and
outputting, by the ANN, caption data comprising one or more captions, wherein one or more of the captions comprise one or more words for providing a visual description for the session of the video game.
